(19) United States
(12) Patent Application Publication
(10) Pub. No.: US 2024/0326059 A1
(43) Pub. Date: Oct. 3, 2024

(54) ACCESSORY FOR A PLATE OF A MICROFLUIDIC EXPERIMENTATION DEVICE, AND MICROFLUIDIC EXPERIMENTATION DEVICE

(71) Applicant: GESVAL S.A., Angleur (BE)

(72) Inventor: Stéphanie VAN LOO, Beaufays (BE)

(73) Assignee: GESVAL S.A., Angleur (BE)

(21) Appl. No.: 18/694,002

(22) PCT Filed: Sep. 21, 2022
(86) PCT No.: PCT/EP2022/076278

§ 371 Date: Mar. 21, 2024

(30) Foreign Application Priority Data
Sep. 21, 2021 (BE) BE 2021/5746

(51) Int. Cl. B01L 9/00; B01L 3/00

(52) U.S. Cl. CPC B01L 9/527; B01L 3/502715; B01L 2200/027; B01L 2200/028; B01L 2300/0609; B01L 2300/0803

(57) ABSTRACT

Plate accessory for a microfluidic experimentation device comprising a first part and at least a second part, said second part being detachable from said first part, said first part having a plurality of through-holes arranged to allow the fluidic connection tubings to pass through said first part, said second part having: at least one housing for at least one microfluidic chip dug into in the thickness of said second part and which has a hole for the passage of light, a plurality of holes, each hole being arranged to receive a fluid reservoir.

The invention relates to a plate accessory for a microfluidic experimentation device with a microfluidic chip and to a microfluidic experimentation device.

Microfluidic experimentation consists of carrying out experiments involving liquid flow in micrometre-sized channels. The fluid flow in these channels results in the viscosity-linked friction forces significantly outweighing the flow-linked inertial forces. We then achieve laminar flow wherein the molecules composing the fluid move along while maintaining their relative positions with respect to one other.

This laminar flow has led to the development of numerous applications including droplet microfluidics. Unlike continuous flow systems, droplet microfluidics systems are based on the fragmentation of a liquid phase into a second immiscible phase (for example water in oil).

Droplet microfluidics systems involve the generation and manipulation of discrete droplets inside microfluidic channels. This method produces well-defined droplets, having a diameter of the order of one micrometre to several hundred micrometres, at a rate of up to twenty thousand droplets per second. By virtue of their large surface-area-to-volume ratio, the phenomena of diffusion and of mass and heat transfer are faster, leading to shorter reaction times. Unlike continuous flow systems, droplet microfluidics systems allow each droplet to be controlled independently, thus generating microreactors that can be individually transported, mixed and analysed.

A major advantage of microfluidic analysis is the capacity to handle very small sample volumes. This means that analyses can be carried out using a small quantity of material and that the consumption of reagents can be reduced.

A microfluidic chip is a set of micro-channels etched or moulded into a material (glass, silicon or polymer such as PDMS, for PolyDimethylSiloxane). The micro-channels forming the microfluidic chip are connected together in order to achieve the desired features such as sorting, separation, mixing. This network of micro-channels trapped in the microfluidic chip is connected to the outside by inputs and outputs pierced through the chip. It is through these holes that the liquids or gases are injected and removed from the microfluidic chip. In addition, in order to be able to monitor, understand and analyse phenomena, microfluidic chips are generally placed on a plate of a microfluidic experimentation device. By plate, we mean any platform of a fluidic experimentation device used to put down the object to be viewed. The platform is preferably horizontal and may advantageously contain a movement system.

More generally, a microfluidic experimentation device comprises, but is not limited to, a microscope module (inverted or not), on either side of a plate, a fluorescence detection module with an excitation light source comprising one or more lasers and photomultiplier detectors, a pneumatic module typically comprising pumps, pressure regulators, solenoid valves, a fluidic module comprising connection tubings, reservoirs, an electronic module equipped with a power supply for components, signal acquisition means, parts and mechanical supports.

Depending on the experiments carried out, the operator will need all the modules or only some of them, more or fewer reservoirs.

There are microfluidic experimentation devices where the modules are integrated, for example in an enclosure, and the modules integrated in the enclosure are typically pneumatic modules. The enclosure containing the pneumatic modules is often arranged underneath the plate of the microfluidic experimentation device. In some microfluidic experimentation devices, the pneumatic module is a separate module to be placed on a table near the microfluidic experimentation device. When it is a fluidic module, arrangements generally vary; some reservoirs may be placed in different locations depending on what they will contain.

Also, before carrying out an experiment or an analysis using a microfluidic chip, the operator must then connect the different gas and liquid inlets and outlets to the circuit(s) of the microfluidic chip(s) using connection tubings. The term connection tubing refers to a flexible hose generally made of PVC (PolyVinyl Chloride), in FEP (Fluorinated Ethylene Propylene), or of silicone, for example a tube or a capillary tube. When certain modules are integrated in an enclosure underneath the plate, connection tubings are connected at one end to these modules while the opposite end ideally ends in the experimentation zone, i.e. above the plate so the operator can handle it. The connection tubings pass through the hole in the plate intended to let light pass through while other connecting tubings connect bottles, flasks or tubes on the table to the microfluidic chip, arranged above the plate. It is not hard to see that microfluidic experiments generally involve a tangle of connection tubings and inconvenient clutter in the workspace. Unfortunately, the operator cannot really move their bottles and flasks further apart because moving them further apart would lengthen the connection tubings, which would then create a dead volume, where analytes of interest may be “lost”, which affects accuracy, and presents the risk of air bubbles.

In fact, the proximity of the reservoirs, and therefore the length of the connection tubings connecting the reservoirs to the chip, depends on the mechanical system for carrying the reservoirs. The further the reservoirs are from the chip, the greater the dead volume contained in these connection tubings. In addition, the assembly is not very robust and is not integral with the chip because sometimes part of the experiment has to be carried out in a sterile hood and it is then necessary to bring the chip and a series of tubes from the sterile hood to the microfluidic experimentation device. In other cases, part of the fluidic circuit, the chip, the reservoirs, etc. must be sterilised beforehand, which does not facilitate the creation of one-piece circuits and reservoirs.

Accessories as described in documents US2020/240898, US2017/014824, US2002/146841 are also known. Unfortunately, in these accessories, access to the microfluidic chip and its movement for carrying out experiments or for assembly in a hood or in a location away from the microscope plate remains problematic.

The invention aims to address these concerns by providing a plate accessory for a microfluidic experimentation device which makes it possible to simplify the handling and the creation of the microfluidic/pneumatic circuit while making the circuit more robust.

To this end, according to the invention, a plate accessory for a microfluidic experimentation device is provided as mentioned at the start, comprising a first part comprising a first wall and at least a second part comprising a second wall of a predetermined thickness, said second part being detachable from said first part, said first wall having a series of through-holes arranged to allow the fluid connection tubings to pass through said first wall, said second wall having:
at least one housing for at least one microfluidic chip dug into the thickness of said second wall and which has a hole for the passage of light from which housing a flat peripheral edge extends, forming a support wall for said at least one microfluidic chip terminated by at least one shoulder in order to connect an upper face of said flat peripheral edge and an upper face of said second wall,
a series of holes, each hole being arranged to receive a fluid reservoir.

As can be seen, the plate accessory for a microfluidic experimentation device according to this invention comprises two parts detachable from each another. The term “detachable” means, for the purposes of this invention, that the second part can be completely separated from the first part because the second part rests on the first part. The second part is detachable from the first part when the second part rests on a shoulder of the first part, when the second part has a shoulder allowing it to rest on the first part, or if the second part overlaps the first part, partially. This allows the second part to be moved and removed, for example vertically, without necessarily having to previously remove the first part. This ease of movement makes it possible to quickly move the microfluidic/pneumatic circuit, for example to bring it to or from a flow hood. It is understood, for the purposes of this invention, that the assembly formed by the second part resting on the first part, thanks to the various means described below, can nevertheless be secured, for example to adjust the centring. Means can therefore be provided for said securing of the assembly, such as clamps, clips, quick connectors, etc.

The first part includes the through-holes for fluidic connection, which connect the pneumatic module and the microfluidic experimentation device. When the pneumatic module is located in an enclosure under the plate, the through-holes allow the connection tubings to pass through the plate but outside the optical field and keep them far enough apart to avoid tangling, while ensuring close proximity to the chip, which will, in turn, be placed in the optical field. Said connection tubings allow liquid or gas to pass through. The second part, which is detachable from the first part, includes holes to house the fluidic part, reservoirs and a housing for the microfluidic chip. Optionally, the holes for supporting fluidic reservoirs have means for clamping the reservoirs, for example, lateral locking screws, spring stops, etc.

Indeed, the presence of holes for supporting fluidic reservoirs on the second part containing the microfluidic chip makes it possible to bring together and connect the series of fluidic reservoirs with the series of microfluidic chips. This bringing-together makes it possible to minimise the dead volume contained in the connection tubings between the fluidic reservoirs and the microfluidic chip. A smaller dead volume makes it possible to carry out microfluidic experiments requiring less fluid and therefore to carry out experiments with very low quantities of product which would be impossible to carry out with a device comprising fluidic reservoirs further away from the microfluidic chip. In addition, reducing dead volume also makes it possible to improve and/or to stabilise the fluid flow in the microfluidic chip. The connection between the microfluidic chip and the fluidic reservoirs as well as the detachable nature of the microfluidic chip support allows the assembly to be moved easily. This allows us to work comfortably in sterile conditions, for example during assembly and mounting of the microfluidic chip, the fluidic reservoirs on the second part of the plate accessory for a microfluidic experimentation device in a laminar flow hood. Once the microfluidic chip is connected to its inlet and outlet reservoirs in the hood, syringe filters (e.g. 0.22 μm) may be added to the pneumatic ends of these inlets and outlets, before the entire assembly is taken out of the hood to be placed in the first part of the accessory located in the plate of the microfluidic experimentation device.

In addition, and very importantly, the fluid reservoirs must be pressurised, so it is necessary to be able to connect the outlets of the pneumatic module to the fluid reservoirs because it is this pressurisation of the reservoirs that pushes the liquids through the connection tubings and the channels of the chip. The plate accessory for a microfluidic experimentation device according to the invention also positions the connection tubings near the reservoirs and thus makes it possible to connect the pneumatic module to the fluidic module easily because the pneumatic outlets and the openings of the reservoirs are in close proximity but also on the same side of the plate, even when the enclosure containing the pneumatic module is underneath the plate.

Advantageously, in the second part, the holes arranged to receive a fluid reservoir of the second wall have a diameter of between 1 and 2 cm.

Advantageously, in the plate accessory for a microfluidic experimentation device according to the invention, said first part comprises fixing means arranged to fix said first part to said plate of a microfluidic experimentation device in a semi-permanent manner. That is to say that the fixing means make it possible to attach and detach the first part to/from the plate as needed, for example, by screwing, clamping, pinching.

Preferably, according to the invention, in the plate accessory for a microfluidic experimentation device, said first part forms a frame around said at least second part, said first part being arranged to be housed in a hole made in said plate, preferably resting on a shoulder found on said plate.

Furthermore, in the plate accessory for a microfluidic experimentation device according to the invention, said frame of said first part comprises an outer edge and an inner edge, said inner edge comprises at least one shoulder on which said second part rests.

Optionally, in the plate accessory for a microfluidic experimentation device according to the invention, said first part comprises an outer edge and an inner edge, said inner edge comprises at least one shoulder on which said second part rests.

Optionally, in the plate accessory for a microfluidic experimentation device according to the invention, said outer edge comprises a second shoulder, said shoulder is present on one side of said inner edge while said second shoulder is present on another side opposite the side comprising the first shoulder, said first shoulder and said second shoulder together form two parallel slides on which said at least one second part rests, optionally on which several second parts rest, and between which said at least one second part moves between, optionally several second parts.

Preferably, in the plate accessory for a microfluidic experimentation device, said inner edge is circular and said shoulder is found on the periphery of said inner edge, said second part being circular and resting on said shoulder in a moveable manner.

Sometimes, in the plate accessory for a microfluidic experimentation device, said second part is connected to manual or motorised control means arranged to allow its movement. This movement may be, for example, a rotation and/or a series of rectilinear movements in the first part 1. Advantageously, in the plate accessory for a microfluidic experimentation device, said housing for at least one microfluidic chip comprises a hollow cavity arranged to introduce therein a means of gripping said microfluidic chip. This gripping means may be a symmetrical or asymmetrical widening which is located on one or more sides of the housing of the microfluidic chip.

Furthermore, in the plate accessory for a microfluidic experimentation device, the housing of the microfluidic chip has a length of between 5 and 10 cm and a width of between 1 and 5 cm.

Optionally, in the plate accessory for a microfluidic experimentation device, the housing for at least one microfluidic chip comprises clamping means arranged to fix the microfluidic chip via mechanical clamping.

Other embodiments of the plate accessory for a microfluidic experimentation device according to the invention are indicated in the attached claims.

This invention also relates to a microfluidic experimentation device.

The microfluidic experimentation device according to the invention comprises, but is not limited to, a microscope module (inverted or not), an optical module, a pneumatic module, a fluidic module, an electronic module, a mechanical module, a piece of user interface software and a plate provided with a housing comprising a hole for housing a plate accessory for a microfluidic experimentation device.

Furthermore, in the microfluidic experimentation device, the pneumatic module, and/or the electronic module, and/or part of the optical module, and/or the fluidic module, and/or part of the microscope module are housed in an enclosure placed underneath the plate.

Advantageously, in the microfluidic experimentation device according to the invention, said first part of the plate accessory for a microfluidic experimentation device is fixed to said plate in a semi-permanent manner thanks to at least one lateral screw.

In an advantageous embodiment according to this invention, the plate, the first and the second part each have an upper face, exposed to the user of the microfluidic experimentation device. The upper faces of the plate, the first and the second part are typically aligned, thus having a substantially continuous surface, optionally pierced with holes or pitted with cavities.

Alternatively, the first and second parts of the accessory are integrated into the plate of the microfluidic experimentation device.

Advantageously, in the microfluidic experimentation device according to the invention, the plate accessory for a microfluidic experimentation device can be moved relative to the optical axis in several dimensions thanks to an x, y or x, y, z moving table.

Sometimes in the microfluidic experimentation device according to the invention, the x, y or x, y, z moving table is controlled manually and/or is motorised.

Other embodiments of the microfluidic experimentation device according to the invention are indicated in the attached claims.

Other features, details and advantages of the invention will be highlighted in the description given below, on a non-limiting basis and with reference to the drawings and examples.

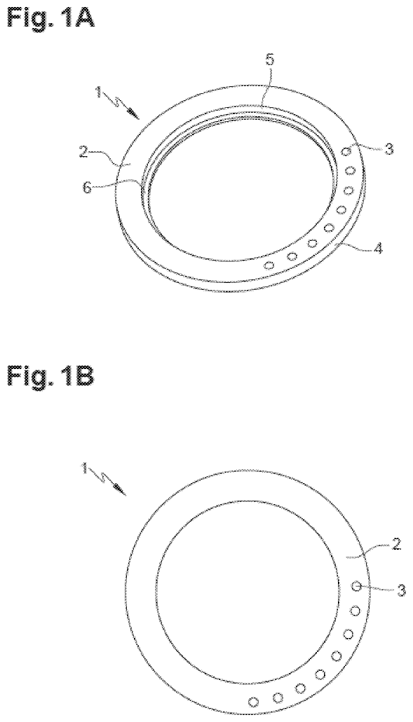

In the drawings, FIG. 1A is a perspective view from above of the first part of the accessory for a plate of a microfluidic experimentation device according to the invention.

FIG. 1B is a bottom view of the first part of the plate accessory for a microfluidic experimentation device according to the invention.

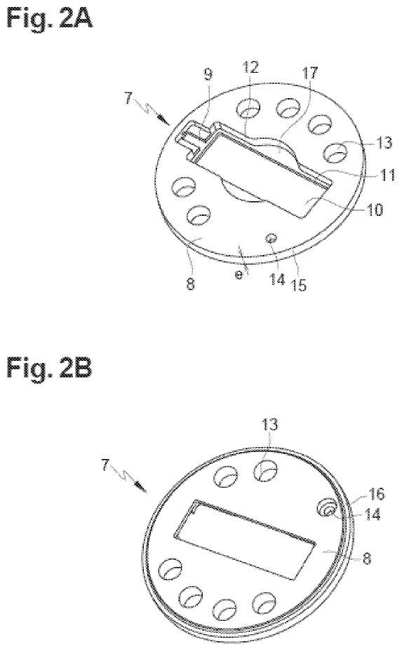

FIG. 2A is a perspective view from above of the second part of the plate accessory for a microfluidic experimentation device according to the invention.

FIG. 2B is a perspective view from below of the second part of the plate accessory for a microfluidic experimentation device according to the invention.

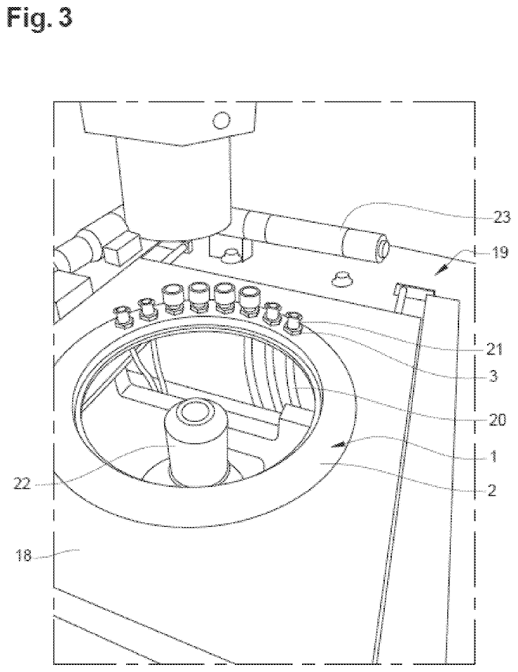

FIG. 3 is a representation of a part of the microfluidic experimentation device wherein the plate of a microfluidic experimentation device comprises the first part of the accessory according to the present invention.

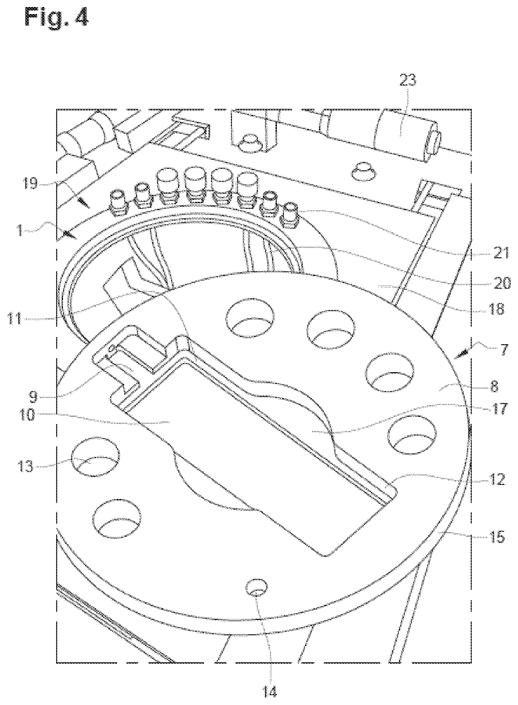

FIG. 4 is an exploded view showing a part of the microfluidic experimentation device in the background and the second part of the plate accessory for a microfluidic experimentation device according to the invention in the foreground.

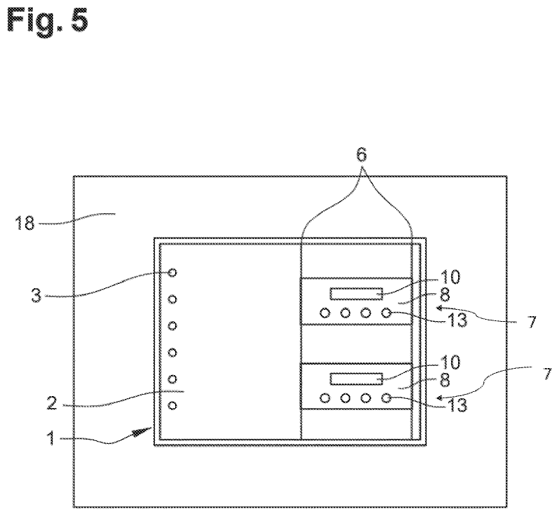

FIG. 5 is a top view of a plate of a microfluidic experimentation device comprising a variant of the accessory for plate of a microfluidic experimentation device according to the invention.

In the figures, identical or similar elements have the same references.

FIGS. 1A and 1B depict the first part 1 of the plate accessory for a microfluidic experimentation device according to the invention. This has a first wall 2 which, in the depicted embodiment, is circular and annular. The first wall 2 has through-holes 3. The first part 1 forms a frame which has an outer edge 4 and an inner edge 5. The inner edge 5 comprises at least one shoulder 6 which is a circular peripheral shoulder in this embodiment.

FIGS. 2A and 2B depict the second part 7 of the plate accessory for a microfluidic experimentation device. This comprises a second wall 8 of a predetermined thickness “e”, a housing 9 of a microfluidic chip, dug into the thickness “e” of said second wall 8. The housing 9 comprises a hole for the passage of light 10, a support wall for the microfluidic chip 11 formed by a flat peripheral edge which extends from the housing 9, more particularly from its side walls 12. The second part also includes holes for microfluidic reservoirs 13, an insertion hole 14 for control means (not depicted) to allow the second part 7 to be put into motion or moved.

The second part 7 comprises, in the depicted embodiment, an outer peripheral edge 15 also provided with a shoulder 16. The second part 7 is intended to be received in the first part 1, with the shoulder 16 of the second part, which cooperates with the shoulder 6 of the inner edge 5 of the first part 1, resting on it.

The housing 9 also comprises a hollow cavity 17 arranged to introduce therein a means of gripping said microfluidic chip, such as for example the finger of the operator or some pliers.

Typically, according to this invention, the housing 9 of the microfluidic chip has a length of between 5 and 10 cm, preferably between 7 and 9 cm and a width of between 1 and 5 cm, preferably between 2 and 3 cm.

As indicated previously, FIG. 3 depicts a part of the microfluidic experimentation device, wherein the plate 18 of the microfluidic experimentation device comprises the first part 1 of the accessory according to the present invention.

The through-holes 3 are passed through by connection tubings 20 terminated by Luer Lock®-type quick connectors 21, whose diameter, which is slightly greater than that of the through-holes 3, allows these quick connectors of the Luer Lock®-type to rest on the upper face of the first wall 2, or the Luer Lock®-type quick connectors 21 can be threaded and screwed into the through-holes 3 or the Luer Lock®-type quick connectors 21 can be glued to the upper face of the first wall 2. Thus the connection tubings 20 arranged underneath the plate 18, connected to the pneumatic module (not visible) in the enclosure under the plate, also each have a connection available above the plate 18, accessible to the operator. The connection tubings 20 are moreover distanced from each other, in an organised manner. The optical module 22 is located underneath the first part of the accessory of a microfluidic experimentation device. The handles of the x,y moving table 23 can be seen in the background of the figure and are used to move the accessory for a plate of a microfluidic experimentation device in both dimensions. We can consider an x, y, z moving table which allows the accessory plate of a microfluidic experimentation device to be moved in three dimensions. This makes it possible to place the part of interest of the microfluidic circuit in the optical axis of the microscope. In the depicted embodiment, the microfluidic experimentation device has an x, y moving table for moving the plate accessory according to this invention which has handles 23 for manually controlling movement, although in some cases movement is carried out by a motor.

The foreground of FIG. 4 depicts the second part 7 of the plate accessory for a microfluidic experimentation device. This is circular and fits inside the first part 1 of the accessory of a microfluidic experimentation device seen in the background.

The housing 9 of the second wall (8) of the plate accessory for a microfluidic experimentation device has a hollow cavity 17 allowing the microfluidic chip to be grasped with a person's fingers or a suitable instrument. The reservoir holes 13 are also located on the second wall (8) and therefore in the immediate vicinity of the housing for the microfluidic chip. This proximity makes it possible to minimise the distance between the reservoirs and the microfluidic chip. A small distance is advantageous because it makes it possible to minimise the size of the connection tubings necessary to connect the reservoirs to the chip and thus to reduce the quantity of fluid required, which is also made possible by the presence of these holes and housing which support and fix the position of the reservoirs and the chip. Thus, any stress in the connection tubings does not lead to the movement of the chip, or the disconnection of the connection tubings, or the overturning of the reservoirs which are typically very light Eppendorf® tubes.

The presence of holes for microfluidic reservoirs 13 near the Luer Lock®-type quick connectors 21 make it possible to easily put the reservoirs under pneumatic pressure without cluttering the experiment space or preventing light from passing through the microfluidic chip and while adequately holding the different elements to which the connection tubings are connected.

When using a microfluidic experimentation device comprising the plate accessory for a microfluidic experimentation device according to the present invention, the pneumatic module is connected to the first part of the accessory 1 with the suitable number of connection tubings. This is facilitated by the fact that the first part 1 of the accessory is detachable from the second part 7, but also from the plate of the microfluidic experimentation device 18. Once the connection tubings 20 have passed through the through-holes 3 of the first wall 2, the placement of Luer Lock®-type quick connectors 21 at the ends of the connection tubings makes it possible to keep them on the upper face of the first wall 2 since the diameter of the Luer Lock®-type quick connectors 21 is greater than the diameter of the through-holes 3. The Luer Lock®-type quick connectors 21 can be threaded and screwed into the through-holes 3. The Luer Lock®-type quick connectors 21 can be glued to the upper face of the first wall 2. The first part of the accessory 1 can then be fixed to the plate of the microfluidic experimentation device 18 using a fixing means. Meanwhile, a microfluidic chip can be placed in the housing 9 of the second part of the accessory 7 and fixed using mechanical clamping means. The microfluidic liquid reservoirs, typically centrifuge tubes, microcentrifuge tubes, or any other tube serving as a reservoir, such as for example Eppendorf® brand tubes or microtubes, can be placed in the holes for microfluidic reservoirs 13. The microfluidic liquid reservoirs can then be connected to the chip using connection tubings. The proximity of the reservoirs and the chip makes it possible to minimise dead volume and also to improve and/or stabilise the fluid flow in the microfluidic chip. Since the reservoirs are stabilised close to the chip, even if the connecting tubing forms a tight U, the risk of the connection tubings detaching from either the reservoir or the chip is reduced. All the experiment elements are thus stabilised and kept at a distance from the optical window of the microfluidic experiment, but at a fixed distance from one other, which makes it possible to minimise distances and therefore dead volumes and as indicated above, to moreover improve and/or stabilise the fluid flow in the microfluidic chip. The accessory can also be used to join the fluidic circuit and make it robust. It can also be moved in whole or in part for the same reasons. Thanks to the independent nature of the second part of the accessory 7 relative to the first part 1 of the accessory, a step involving conditioning the chip positioned in the second part of the accessory can be performed, for example, in a laminar flow hood in order to keep the experiment in sterile conditions, or in another type of hood or enclosure (climatic, safety, chemical, etc.). Once the chip is connected to its inlet and outlet reservoirs in the hood, all in the second part 7 of the accessory, syringe filters may be added to the pneumatic ends of these inlets and outlets, before all the assembly has come out of the hood and the second part conditioned with the chip and the reservoirs may then be placed in the first part of the accessory 1. It then remains to connect the pneumatics, from the quick connectors 21 protruding from the through-holes 3, to the microfluidic reservoirs to allow the liquids to be pushed into the chip. The arrangement of the quick connectors 21 on the upper part of the plate of the microfluidic experimentation device 18 allows for simple and practical connection, and the connection tubings remain organised and are not placed in the optical window of the microfluidic experiment.

As indicated previously, FIG. 5 depicts a part of the microfluidic experimentation device, wherein the plate 18 of the microfluidic experimentation device comprises the first part 1 of a variant of the accessory according to this invention. The first part is in this rectangular embodiment. On its inner edge it has two shoulders 6, which face each other while being arranged on opposite side walls of the inner edge. These two shoulders form two slides on which rest two second parts 7 of the plate accessory for a microfluidic experimentation device according to the invention. In this embodiment, the second parts 7 are rectangular in shape. The second parts 7 can move independently of each other on these slides.

It is of course understood that this invention is in no way limited to the embodiments described above and that many modifications may be made without departing from the scope of the appended claims.

1. Plate accessory for a microfluidic experimentation device comprising a first part comprising a first wall and at least a second part comprising a second wall of a predetermined thickness, said second part being detachable from said first part, said first wall having a plurality of through-holes arranged to allow the fluidic connection tubings to pass through said first wall, said second wall having:
at least one housing for at least one microfluidic chip dug into the thickness of said second wall and which has a hole for the passage of light from which a flat peripheral edge extends, forming a support wall for said at least one microfluidic chip terminated by at least one shoulder in order to connect an upper face of said flat peripheral edge and an upper face of said second wall,
a plurality of holes, each hole being arranged to receive a fluid reservoir.

2. Plate accessory for a microfluidic experimentation device according to claim 1, wherein said first part comprises fixing means arranged to fix said first part to said plate of a microfluidic experimentation device in a semi-permanent manner.

3. Plate accessory for a microfluidic experimentation device according to claim 1, wherein said first part forms a frame around said at least second part, said first part being arranged to be housed in a hole made in said plate, preferably resting on a shoulder found on said plate.

4. Plate accessory for a microfluidic experimentation device according to claim 1, wherein said first part comprises an outer edge and an inner edge, said inner edge comprising at least one shoulder on which said second part rests.

5. Plate accessory for a microfluidic experimentation device according to claim 4, wherein said inner edge comprises a second shoulder, said shoulder being found on one side of said inner edge while said second shoulder is found on another side opposite the side comprising the first shoulder, said first shoulder and said second shoulder together forming two parallel slides on which said at least one second part rests, optionally on which several second parts rest, and between which said at least one second part moves, optionally several second parts.

6. Plate accessory for a microfluidic experimentation device according to claim 4, wherein said inner edge 5 is circular and where said shoulder is found on the periphery of said inner edge, said second part being circular and resting on said shoulder in a moveable manner.

7. Plate accessory for a microfluidic experimentation device according to claim 1, wherein said second part is connected to manual or motorised control means arranged to allow its movement.

8. Plate accessory for a microfluidic experimentation device according to claim 1, wherein said housing for at least one microfluidic chip comprises a hollow cavity arranged to introduce a means for gripping said microfluidic chip.

9. Plate accessory for a microfluidic experimentation device according to claim 1, wherein the housing for at least one microfluidic chip 9 has a length of between 5 and 10 cm and a width of between 1 and 5 cm.

10. Plate accessory for a microfluidic experimentation device according to claim 1, wherein the housing for at least one microfluidic chip comprises clamping means arranged to fix the microfluidic chip via mechanical clamping.

11. Microfluidic experimentation device for a microfluidic chip comprising a microscopy module, an optical module, a pneumatic module, a fluidic module, an electronic module, a mechanical module, a piece of user interface software and a plate arranged to accommodate a plate accessory for a microfluidic experimentation device according to claim 1.

12. Microfluidic experimentation device for a microfluidic chip according to claim 11, wherein the pneumatic module, and/or the electronic module, and/or part of the optical module, and/or the fluidic module, and/or part of the microscope module are housed in a enclosure placed underneath the plate.

13. Microfluidic experimentation device for a microfluidic chip according to claim 12, wherein said first part of the accessory for a plate of a microfluidic experimentation device is attached to said plate in a semi-permanent manner thanks to at least one side screw.

14. Microfluidic experimentation device for a microfluidic chip according to claim 11, wherein the accessory for a plate of a microfluidic experimentation device can be moved relative to the optical axis in several dimensions thanks to an x, y or x, y, z moving table.

15. Microfluidic experimentation device for a microfluidic chip according to claim 14, wherein the x, y or x, y, z moving table is manually controlled and/or is motorised.
